(19) United States
(12) Patent Application Publication
(10) Pub. No.: US 2011/0133355 A1
(43) Pub. Date: Jun. 9, 2011

(54) Extruder Having Dual Mixing Stages And Process For Preparing A Mixture Of Polymer And Diluent

(76) Inventors: Kotaro Takita, Kanagawa-ken (JP); Norimitsu Kaimai, Kanagawa-ken (JP); Sadakatsu Suzuki, Saitama-ken (JP)

(21) Appl. No.: 12/681,674

(22) PCT Filed: Oct. 20, 2008
(86) PCT No.: PCT/JP2008/069391

§ 371 Date: Nov. 19, 2010

Related U.S. Application Data
(60) Provisional application No. 60/981,218, filed on Oct. 19, 2007.
(60) Provisional application No. 60/981,279, filed on Oct. 19, 2007.
(60) Provisional application No. 60/985,028, filed on Nov. 2, 2007.
(60) Provisional application No. 60/986,748, filed on Nov. 9, 2007.

(30) Foreign Application Priority Data
Apr. 24, 2008 (EP) 08155116.0

(51) Int. Cl. C08J 9/26; B29B 7/80

(52) U.S. Cl. 264/49; 366/76.6

(57) ABSTRACT

An extruder for preparing a polymer-diluent mixture. The extruder includes an elongated housing having an inlet end, an outlet end and a bore disposed within the housing, an elongated extruder shaft having an axis of rotation, the elongated extruder shaft disposed within the bore and drivable in at least one direction of rotation, a plurality of extruder screw segments positioned along the elongated extruder shaft in a fixed angular relationship therewith, the plurality of extruder screw segments selected to form multiple extruder stages, the multiple extruder stages comprising an inlet stage, a dispersion stage, and at least one mixing stage, the plurality of extruder screw segments forming the at least one mixing stage comprising a reverse mixing screw segment having a helical flight that traverses and forms an outer periphery thereof, the helical flight having a plurality of notches positioned therealong, a material inlet adjacent the inlet end of the elongated barrel and a first fluid inlet located within the dispersion stage for introducing a diluent. A process for extruding a polymer-diluent mixture is also provided.

### FIELD OF THE INVENTION

This disclosure relates generally to an extruder for preparing a polymer-diluent mixture and, more particularly, to extruder screw configurations for use therein. The disclosure also relates to a process for producing such a mixture. Such mixtures are useful for producing microporous film, such as battery separator film.

### BACKGROUND OF THE INVENTION

In the processing of polymeric resins and other materials, extruders are commonly employed for the plastication, mixing and pumping of such materials. In their simplest form, extruders include a frame designed to be bolted to a concrete floor, a barrel mounted to the frame, and, in the case of a twin screw extruder, two interconnecting bores extending longitudinally from one end of the barrel to the other. A twin screw extruder also includes two intermeshing screws located within the two interconnecting bores and drive means for turning the screws in the same (co-rotating) or opposite (counter-rotating) direction.

Polymeric materials are useful for the fabrication of a variety of films, sheets and molded or shaped articles. As is well-known to those skilled in the art, plastication refers to the softening of a polymeric material to such an extent that it flows freely and will assume any shape. In the case of a polymeric material that is crystalline, plastication is synonymous with melting. In the case of a polymeric material that is amorphous, plastication occurs at or about the glass transition temperature (T_{g}) thereof.

An extruder screw is shaped generally in the form of an elongated cylinder, and has one or more raised ridges helically disposed thereabout, each of which is a commonly referred to as a flight. A flight may have forward, reverse or neutral pitch, with the degree of pitch varied to accommodate a particular application. The surface of the screw above which the flight is raised is commonly referred to as the root of the screw. When the screw is viewed in cross section, the course of a particular flight, between one point of intersection with a line parallel to the screw axis and the next closest point of intersection of the flight with such line, typically defines a 360° circle. The tip of a flight, which extends toward the perimeter of such circular-shaped cross section, defines a lobe above the root of the screw. The space bounded by the root of the screw and the side walls of any two flights is a channel of the screw. The screw rotates on its longitudinal axis within a barrel or sleeve, which may be generally described as the bore of an annular cylinder.

The screw typically has an initial, feed section which begins the process of conveying solid polymeric material forward within the barrel of the extruder. Polymeric material may be fed into the extruder by means of a hopper which empties into the barrel, or may be metered into the barrel through a feed chute or a side feeder. The direction of travel of the polymeric material in the barrel as it is transported away from the feed port by the screw is known as the downstream direction. In the case of the extrusion of polymer melts, the feed or inlet section of the screw is typically followed, with or without other intervening sections, by a melting section in which partial or complete plastication of the polymeric material occurs.

The melting section of the screw is typically followed, with or without other intervening sections, by a metering section which functions to pump the material, as extrudate, out through the downstream end of the extruder, which typically contains a die or some other form of restricted orifice. The sections of the extruder and screw through which the polymeric material travels before it reaches the die are considered to be upstream from the die.

With respect to a twin screw extruder, two screws are said to be intermeshing if a flight of one screw is disposed within a channel of the other screw. In such a configuration, the distance between the axes of each screw is less than the sum of the respective radii of the two screws, when each radius is measured from the axis to the top of the tallest or highest flight of the screw. When, on a pair of screws, a flight has a shape and size such that its fit into a channel in which it is intermeshed is close enough that essentially no extrudable material passes through the space between the flight and channel, the screws are said to be conjugated. Otherwise, the screws are said to be non-conjugated, and the degree of intermeshing in the case of non-conjugation can be varied to an essentially unlimited extent.

Co-rotating screws, even when conjugated, allow for extensive movement of polymeric material laterally from one screw to the other. Mixing is benefited by this movement and it is further enhanced when the screws are not conjugated. The shape of the flights on non-conjugated screws may be arranged to create the passage of polymeric material from one channel into two channels on another screw. Or, when screws are conjugated, or essentially conjugated, certain flights can be designed in a shape such that they wipe each other in the zone of intermeshing but do not wipe the wall of the barrel.

The production of certain specialty films, such as microporous polyolefin membranes, has presented unique requirements in the design of extruders. This is due in large part by the need to introduce a large amount of a solvent or diluent for the polymeric raw material, e.g., polyolefin resin, so that a polymeric solution is prepared for subsequent extrusion. Microporous polyolefin membranes are useful as separators for primary batteries and secondary batteries such as lithium ion secondary batteries, lithium-polymer secondary batteries, nickel-hydrogen secondary batteries, nickel-cadmium secondary batteries, nickel-zinc secondary batteries, silver-zinc secondary batteries, etc. When the microporous polyolefin membrane is used as a battery separator, particularly as a lithium ion battery separator, the membrane's performance significantly affects the properties, productivity and safety of the battery. Accordingly, the microporous polyolefin membrane should have suitably well-balanced permeability, mechanical properties, dimensional stability, shutdown properties, meltdown properties, etc. The term “well-balanced” means that the optimization of one of these characteristics does not result in a significant degradation in another.

As is known, it is desirable for the batteries to have a relatively low shutdown temperature and a relatively high meltdown temperature for improved battery safety, particularly for batteries exposed to high temperatures under operating conditions. Consistent dimensional properties, such as film thickness, are essential to high performing films. A separator with high mechanical strength is desirable for improved battery assembly and fabrication, and for improved durability. The optimization of material compositions, casting and stretching conditions, heat treatment conditions, etc. have been proposed to improve the properties of microporous polyolefin membranes.

In general, microporous polyolefin membranes consisting essentially of polyethylene (i.e., they contain polyethylene only with no significant presence of other species) have relatively low meltdown temperatures. Accordingly, proposals have been made to provide microporous polyolefin membranes made from mixed resins of polyethylene and polypropylene, and multi-layer, microporous polyolefin membranes having polyethylene layers and polypropylene layers in order to increase meltdown temperature. The use of these mixed resins and the production of multilayer films having layers of differing polyolefins can make the production of films having consistent dimensional properties, such as film thickness, all the more difficult.

U.S. Pat. No. 5,573,332 proposes a screw element for a screw-type extrusion machine. The screw elements are helical and have varying pitch directions. Lengthwise mixing is obtained by the screwing in opposite directions, whereas crosswise mixing is attained by the elongated wedge of the flank arc. This crosswise flow is a typical continuous shear flow, which is primarily a dispersive mixing operation. Dividing the flow into various partial flows, recirculation and offset combination do not take place. The extruder proposed is for use in preparing a polymer melt and does not relate to the field of polymer solution extrusion.

U.S. Pat. No. 6,062,719 proposes a co-rotating multiple-screw extruder comprising first and second intermeshing screws of more than one flight. The first screw comprises first and second segments paired with first and second segments of the second screw, respectively. On the first segment of the first screw, the height of the first flight is less than the height of the second flight and on the second segment of the second screw, the height of the first flight is less than the height of the second flight and screws for use in such extruder. The extruder proposed is for use in preparing a polymer melt and does not relate to the field of polymer solution extrusion.

U.S. Publication No. 20050013192 proposes a kneading disk having a plurality of disk elements having flight tips arranged at a helix angle E in a direction supporting main streams of a resin. The flight tips of every two adjoining disks have a clearance formed therebetween. The resin is kneaded by undergoing dispersion and distribution without having any excessive temperature elevation in approximately three kinds of streams, i.e. its main streams flowing along the flight tips, its back streams through the clearances and its tip riding streams flowing over the flight tips. The reference discloses a continuous or “rotor”-type screw segment in the “dispersion” region of the extruder for improved melt-shearing in that region. When distribution or “stirring” in needed, a discontinuous or “disk-type” segment having disk elements arranged along a screw axis and flight tips arranged discontinuously and helically in parallel to the screw axis is employed. Polymer flowing counter-currently in the regions between the flight tips (see, e.g., FIG. 7) increases polymer residence time to increase mixing uniformity. With conventional screw segments, the L/D value is small and multiple segments are needed to get good dispersion. This however leads to a problem since, at the interface between two segments in registry, what is effectively produced is a lobe that is twice as long as the interior lobes. This abruptly changes the “pitch” of the flight of lobes. Moreover, the total number of lobes is reduced by the number of segment interfaces. All of these effects serve to reduce the amount of beneficial countercurrent polymer flow.

JP7-216118A discloses a battery separator formed from a porous film comprising polyethylene and polypropylene as indispensable components and having at least two microporous layers each with different polyethylene content. The polyethylene content is 0 to 20% by weight in one microporous layer, 21 to 60% by weight in the other microporous layer, and 2 to 40% by weight in the overall film. The battery separator has relatively high shutdown-starting temperature and mechanical strength. Since this is a “dry” process, the resins are combined as a polymer melt and then extruded.

WO 2004/089627 discloses a microporous polyolefin membrane made of polyethylene and polypropylene comprising two or more layers, the polypropylene content being more than 50% and 95% or less by mass in at least one surface layer, and the polyethylene content being 50 to 95% by mass in the entire membrane. The membrane is made in a wet process, where polymer and a plasticizer are combined by melt blending in a double screw mixer for example. Generally, it is advantageous to combine the polymer first in an inlet stage where the polymer resins can be blended or distributed amongst themselves before adding the plasticizer.

WO 2005/113657 discloses a microporous polyolefin membrane having conventional shutdown properties, meltdown properties, dimensional stability and high-temperature strength. The membrane is made using a polyolefin composition comprising (a) composition comprising lower molecular weight polyethylene and higher molecular weight polyethylene, and (b) polypropylene. This microporous polyolefin membrane is produced by a so-called “wet process”.

As those skilled in the art will plainly recognize, extruder screw design requirements for extruding polymer melts differ greatly from those relating to polymer solutions. While much work has been conducted with respect to polymer melts, this work largely fails to translate to the field of polyolefin solution extrusion. Since polyolefin solutions behave differently from polymer melts, those skilled in the art recognize that there is no expectation that a combination of extruder screw segments used for extruding a polymer melt will yield satisfactory performance when extruding a polymer solution. As may be appreciated by those working in the field of polymeric solution extrusion, a counter current flow of the solvent or diluent phase is always undesirable. As such, it is desirable to have no solvent in the inlet stage of an extruder, since even a small amount of solvent would interfere with polymer blending.

A further problem relating to the extrusion of polymer solutions involves the fact that the knowledge base relating thereto is limited. While it is generally recognized that single and twin-screw extruders can be used, information as to which particular extruder segments or combinations of segments have utility is very limited.

JP 2003-053821 discloses a wet process for manufacturing a microporous film where a polyolefin solution is extruded through a twin-screw extruder and each screw contains at least one of (a) a normal screw-notch screw element, (b) a reverse screw-notch screw element, and (c) a collar. This arrangement is said to benefit the mixing of different kinds and molecular weight polymers. As may be appreciated, the problems identified with respect to U.S. Publication No. 2005/0013192 are addressed by the introduction of a reverse-pitch segment.

JP Publication Nos. 8-109268, 8-120093, 8-164518, 8-224735, 8-245798 and 8-109268 each relate to the field of polymeric solution extrusion. While having an upstream pressure greater than the pressure at the point of solvent injection may be proposed, no teaching as to how this may be achieved is disclosed within any of the aforementioned publications.

Despite these advances in the art, there remains a need for improved extrusion systems capable of producing high quality microporous polyolefin membranes and other films or sheets from polymer solutions.

### SUMMARY OF THE INVENTION

In one aspect, provided is an extruder for preparing a mixture of polymer and diluent, e.g., a polymeric solution. The extruder includes an elongated housing having an inlet end, an outlet end and a bore disposed within the housing, an elongated extruder shaft having an axis of rotation, the elongated extruder shaft disposed within the bore and drivable in at least one direction of rotation, a plurality of extruder screw segments positioned along the elongated extruder shaft in a fixed angular relationship therewith, the plurality of extruder screw segments selected to form multiple extruder stages, the multiple extruder stages comprising an inlet stage, a dispersion stage, and at least one mixing stage, the plurality of extruder screw segments forming the at least one mixing stage comprising a reverse mixing screw segment having a helical flight that traverses and forms an outer periphery thereof, the helical flight having a plurality of notches positioned therealong, a material inlet adjacent the inlet end of the elongated barrel and a first fluid inlet located within the dispersion stage for introducing at least one diluent.

In another aspect, provided is a twin screw extruder for preparing a mixture of polymer and diluent, e.g., polymeric solution. The extruder includes an elongated housing having an inlet end, an outlet end and a pair of interconnecting bores disposed within the housing, a pair of elongated extruder shafts each having an axis of rotation, the pair of elongated extruder shafts disposed within the pair of interconnecting bores and drivable in at least one direction of rotation, a plurality of extruder screw segments positioned along the pair of elongated extruder shafts in a fixed angular relationship therewith, the plurality of extruder screw segments selected to form multiple extruder stages, the multiple extruder stages comprising an inlet stage, a dispersion stage, and at least one mixing stage, the plurality of extruder screw segments forming the at least one mixing stage comprising a reverse mixing screw segment having a length of from about 0.50 D to about 1.50 D, the reverse mixing screw segment having a helical flight that traverses and forms an outer periphery thereof, the helical flight having a plurality of notches positioned therealong, a material inlet adjacent the inlet end of the elongated barrel, and a first fluid inlet located within the dispersion stage for introducing at least one diluent.

In yet another aspect, provided is a process for extruding a polymer-diluent mixture, e.g., a polymeric solution. The process includes the steps of blending at least one polymer at a rate of P grams per second in an inlet stage and conducting the blended polymer to a dispersion stage, adding at least one diluent to the blended polymer in the dispersion stage at a rate of S grams per second, the diluent (e.g., a solvent) having a lower viscosity than the polymer, dispersing the diluent in the polymer, and conducting the dispersed diluent to a first mixing stage, the first mixing stage including a reverse mixing screw segment having a helical flight that traverses and forms an outer periphery thereof, the helical flight having a plurality of notches positioned therealong, and blending the dispersed diluent and the blended polymer in the first mixing stage to produce a third stage product, the third stage product comprising (i) the polymer-diluent mixture in a first phase, (ii) a portion of the diluent in a second phase separate from the first phase, and (iii) a portion of the polymer in a third phase separate from the first and second phases, wherein the mixing energy in the first mixing stage is greater than the mixing energy in either the inlet stage or the dispersion stage.

In an exemplary form disclosed herein, the extruder further includes a second mixing stage, the plurality of extruder screw segments forming the second mixing stage comprising a reverse mixing screw segment having a length of from about 0.50 D to about 1.50 D, the reverse mixing screw segment having a helical flight that traverses and forms an outer periphery thereof, the helical flight having a plurality of notches positioned therealong.

In a further exemplary form disclosed herein, the extruder further includes an outlet stage, the plurality of extruder screw segments forming the outlet stage comprising eight first forward full flight screw segments, three second forward full flight screw segments and three third forward full flight screw segments.

In a yet further exemplary form disclosed herein, the dispersion stage includes at least one kneading segment comprising 17 kneading disks, wherein each adjacent flight tip of each kneading disk is progressively offset by an angle θ equal to about 45°.

In a yet further exemplary form disclosed herein, the elongated extruder shafts are co-rotating.

In a still yet further exemplary form disclosed herein, the elongated extruder shafts are counter-rotating.

In a still yet further exemplary form disclosed herein, the process further includes the steps of extruding the polymer-diluent mixture through an extrusion die, the extrusion die comprising a die outlet, e.g., a slot, through which a stream of the polymer solution is extruded; and cooling the extrudate to form a cooled extrudate.

These and other advantages, features and attributes of the disclosed extruder and process and its advantageous applications and/or uses will be apparent from the detailed description that follows, particularly when read in conjunction with the figures appended hereto.

### BRIEF DESCRIPTION OF THE DRAWINGS

FIG. 1 is a diagrammatic illustration of a lateral longitudinal view of a twin screw extruder, in accordance herewith;

FIG. 2 is a cross-section through the extruder on the line 2-2 of FIG. 1 with the illustration of two kneading segments, in accordance herewith;

FIG. 3 is a schematic of a screw segment configuration for preparing a polymer solution, in accordance herewith;

FIG. 4A shows a kneading segment of an extruder screw, in accordance herewith;

FIG. 4B shows an end view of the kneading segment of FIG. 6A, in accordance herewith;

FIG. 5 is a schematic of another screw segment configuration for preparing a polymer solution, in accordance herewith;

FIG. 6A shows a reverse mixing screw segment of an extruder screw, in accordance herewith; and

FIG. 6B shows an end view of the reverse mixing screw segment of FIG. 6A, in accordance herewith.

### DETAILED DESCRIPTION OF THE INVENTION

### Definitions

By “forward flight screw segment” is meant a continuous conveying element having a flight angle sufficient to cause flow in a direction from the inlet end to the outlet end of the extruder. Suitable forward flight screw segments may be obtained from Japan Steel Works of Tokyo, Japan, and may include segments such as H259, H261, H262 and H265.

By “forward screw segment” is meant a screw element with a flight pitch designed to convey material forward to the screw segment ahead of it.

By “gear kneading segment” is mean a screw segment having a plurality of gear-like kneading disks. Suitable gear kneading segments may be obtained from Japan Steel Works of Tokyo, Japan, and may include neutral gear kneading segments such as H726 and H727.

By “kneading segment” is meant a screw segment that may be continuous or discontinuous. Examples of discontinuous kneading segments include single and dual flight kneading segments having a plurality of lobed kneading disks and gear kneading segments having a plurality of gear-like kneading disks. The length or thickness of the kneading disks typically range between a few to a several millimeters, for example from 2 mm to 100 mm, depending on the required dispersion rate of mixing. A continuous kneading segment may have the shape of a continuous conveying element with a flight angle of 90° so as to cause no flow in either direction.

By “reverse screw segment” is meant a screw element with a pitch designed to convey material back to the screw segment preceding it, creating a filled barrel section.

By “screw configuration” is meant the general profile of the screw resulting from the change of its geometric characteristics and/or the organization of successive screw segments, insuring different functions are performed along its length.

By “segment” or “screw segment” is meant an extrusion screw element, positioned along a keyed or splined shaft, which conveys, shears, pressurizes, heats and/or transforms materials into a continuous solution or mass. Such elements may be of the conveying type or non-conveying or kneading type.

By “single flight” or “dual flight kneading segment” is meant a kneading segment having a plurality of lobed kneading disks. Suitable single flight or dual flight kneading segments may be obtained from Japan Steel Works of Tokyo, Japan, and may include forward kneading segments such as H266 and H267, reverse kneading segments, such as H299, or neutral kneading segments, such as H294 and H306.

By “twin screw extruder” is meant a machine having two parallel screw shafts running side by side in a double-bored barrel for the mixing and processing of products, such as polymer solutions.

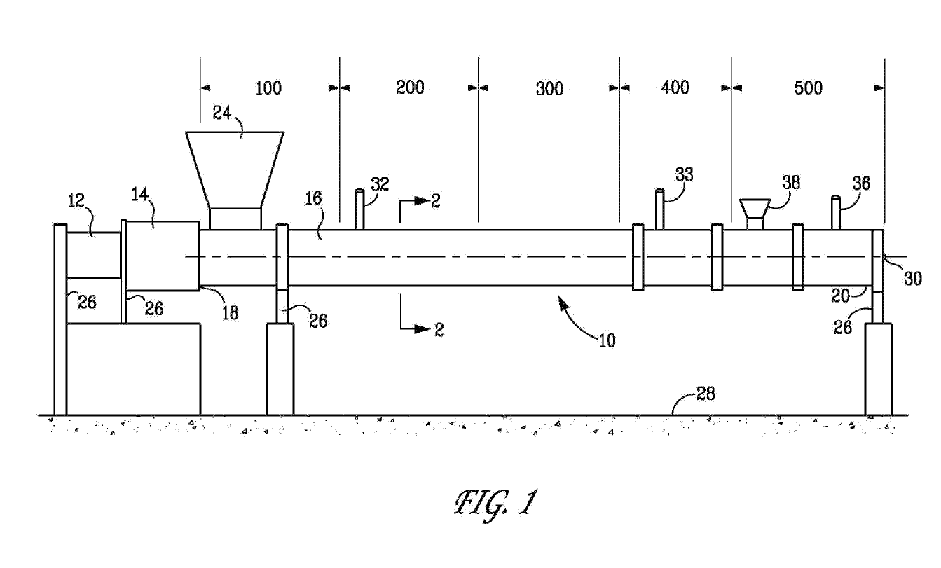

Reference is now made to FIGS. 1-6B, wherein like numerals are used to designate like parts throughout.

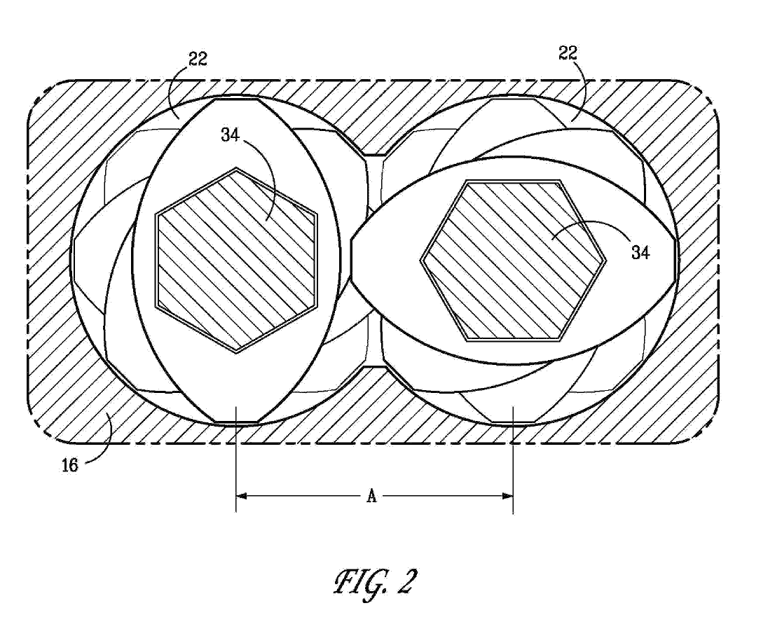

Referring now to FIG. 1, a twin screw extruder 10 is shown. Twin screw extruder 10 may be obtained from Japan Steel Works of Tokyo, Japan, and may be a Model TEX 54, TEX 65, or the like, for commercial use, or may be a TEX30, TEX44, or the like, for small-scale and laboratory use. Other polyolefin extruders may be employed, as those skilled in the art will readily understand. Twin screw extruder 10 includes a drive motor 12, a gear mechanism 14 joined thereto on the input side and a housing 16 having an inlet end 18 and an outlet end 20. As shown in FIG. 2 housing 16 includes a pair of interconnecting bores 22 disposed within housing 16. Referring again to FIG. 1, provided on housing 16 is an inlet hopper 24 for the supply of thermoplastic material to be processed. The aforementioned components of the extruder 10 are supported by a plurality of props 26 positioned on a foundation 28 and joined thereto. Above the inlet hopper 24 may be positioned metering devices (not shown) for the metered addition of plastic pellets or other materials to the inlet hopper 24. At the end of the housing 16, which is downstream of the inlet end 18 and adjacent the outlet end 20 is a discharge opening 30 for the discharge of the material processed in the extruder 10. At least one diluent, e.g., a solvent for the thermoplastic material (the polymer or mixture of polymers), may be introduced at a first injection tube 32 and, optionally, at a second injection tube 33.

Referring again to FIG. 2, interconnecting bores 22 of housing 16 are parallel to each other. A pair of elongated extruder shafts 34, each having an axis of rotation, are disposed within the pair of interconnecting bores 22 and drivable in at least one direction of rotation by being joined to the power take-off side of gear mechanism 14, gear mechanism 14 driven by drive motor 12. In one form, to enable the keying of a plurality of screw segments to the pair of elongated extruder shafts 34, the pair of elongated extruder shafts 34 may be provided with a square, pentagonal, hexagonal or octagonal cross section or a cross section defined by a perimeter formed by a plurality of scallops.

As will be described in more detail below, a variety of screw segments are provided in a non-rotatable, fixed angular relationship on the elongated extruder shafts 34, such as intermeshing screws segments and kneading disks, which are selected in dependence on their function and disposed successively in the along the pair of elongated extruder shafts 34.

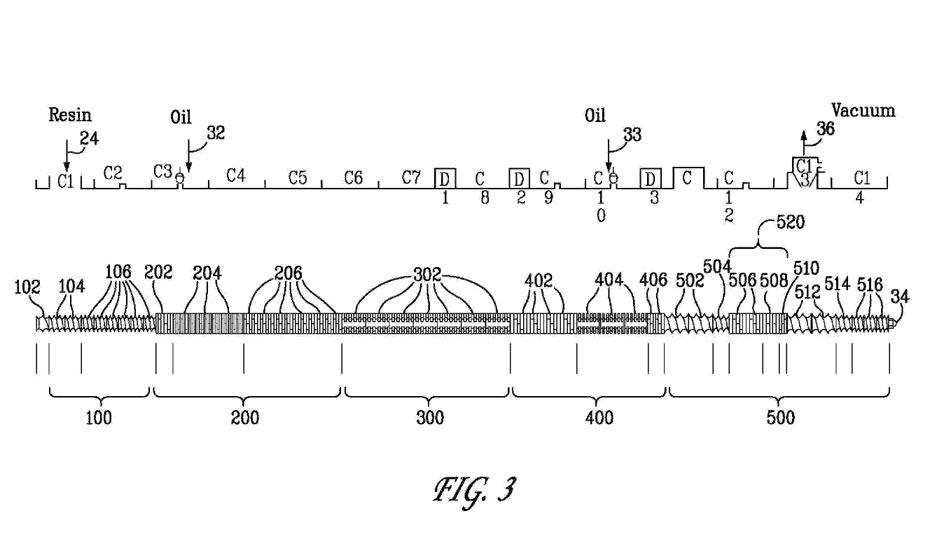

Referring now to FIG. 3, a plurality of extruder screw segments are shown, the plurality of extruder screw segments selected to form multiple extruder stages. In one form, the multiple extruder stages include an inlet stage 100, a dispersion stage 200, a first mixing stage 300, a second mixing stage 400, and an outlet stage 500. These stages are also shown with respect to extruder 10 in FIG. 1. Each stage will now be described with reference to FIG. 3.

A plurality of extruder screw segments is provided to form inlet stage 100. As shown in FIG. 1, inlet stage 100 initiates near first end 18, terminates at dispersion stage 200 and is positioned so as to receive thermoplastic material from inlet 24 for processing. As shown in FIG. 3, in one form, inlet stage 100 includes a first forward full flight screw segment 102, a pair of second forward full flight screw segments 104, and six third forward full flight screw segments 106. In one form, first forward full flight screw segment 102 has a length of 0.75 X extruder screw diameter “D.” Second forward full flight screw segment 104 has a length of 1.00 D, for a total length of 2.00 D for the pair. Third forward full flight screw segment 106 also has a length of 0.75 D, for a total length of 4.50 D. In one form, third forward full flight screw segment 106 ha a shorter pitch than the pair of second forward full flight screw segments 104. In one form, inlet stage 100 has a length L of about 10% L≦Lᵢ≦about 30% L, where L is the total length of extruder shaft 34.

Referring still to FIG. 3, a plurality of extruder screw segments is provided to form dispersion stage 200. As shown in FIG. 1, dispersion stage 200 follows inlet stage 100, terminates at first mixing stage 300 and is positioned so as to receive a liquid solvent from first fluid inlet 32 for mixing with the thermoplastic material introduced at inlet stage 100. As shown in FIG. 3, in one form, dispersion stage 200 includes a pre-kneading segment 202, three first kneading segments 204, and twelve second kneading segments 206. In one form, the ability of pre-kneading segment 202 to the move material forward is lower than that of third forward full flight screw segment 106 and second kneading segment 206. In one form, pre-kneading segment 202 has a length of 1.00 D. First kneading segment 204 has a length of 1.50 D, for a total length of 4.50 D for the three first kneading segments 204. Second kneading segment 206 has a length of 0.50 D, for a total length of 6.00 D for the twelve second kneading segments 206. In one form, dispersion stage 200 has a length L_{d} of about 15% L≦L_{d}≦about 35% L, where L is the total length of extruder shaft 34.

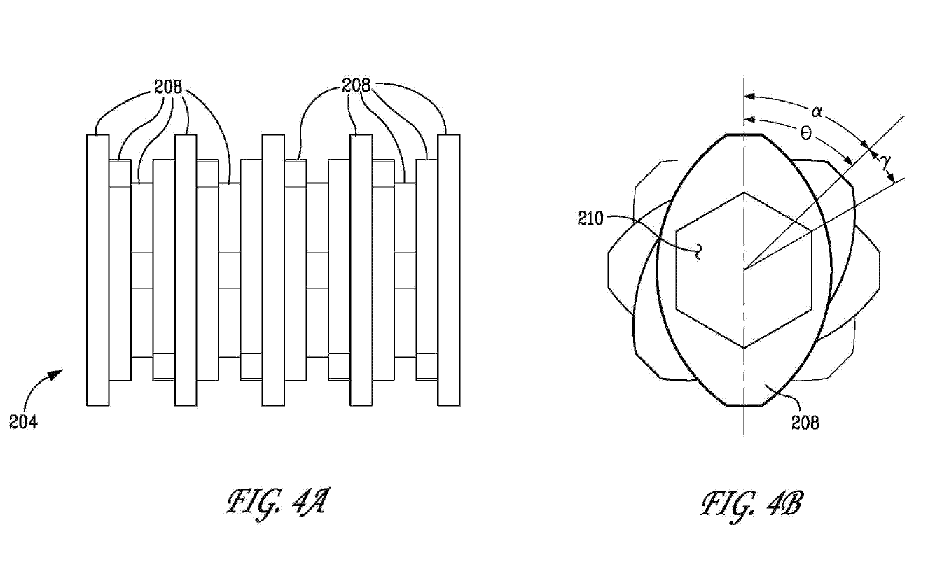

As shown in FIG. 4A, in one form, first kneading segment 204 includes a plurality of kneading disks 208. As may be seen by reference to FIG. 4B, each adjacent flight tip of kneading disks 208 is progressively offset by an angle θ, wherein 0°<θ<90° or angle θ may equal about 45°. In another form, the number of kneading disks is greater than 10 and is selected to achieve an offset angle between a flight tip of a last kneading disk 208 of the at least one first kneading segment and a flight tip of a first kneading disk 208 of an adjacent kneading segment equal to about 0°. In yet another form, the number of kneading disks 208 and angle θ are selected to enable an adjacent kneading segment 204 to be positioned to achieve an offset angle between a flight tip of a last kneading disk 208 of the at least one first kneading segment 204 and a flight tip of a first kneading disk 208 of an adjacent kneading segment substantially equivalent to the angle θ.

In one form, the pair of elongated extruder shafts 34 has a hexagonal cross section and the offset angle θ is defined as 40°≦θ<50°. In another form, angle θ is equal to about 45°. In yet another form, the number of kneading disks 208 of first kneading segment 204 is greater than 15. In still yet another form, the number of kneading disks 208 of first kneading segment 204 is 17 and the offset angle between a flight tip of a last kneading disk 208 of the at least one first kneading segment and a flight tip of a first kneading disk 208 of an adjacent kneading segment equal to about 0°. As may be appreciated, the greater the number of kneading disks 208 of the first kneading segment 204, the more efficient the dispersion. Also the thinner the disk thickness is, the more efficient the dispersion.

Traditionally, kneading segments are identified by offset angle/number of disks/disk length/segment length. As such, in one form, first kneading segment 204 is a 45/17/0.09 D/1.5 D forward kneading segment, while second kneading segments 206 is a 45/5/0.10 D/0.50 D forward kneading segment. As may be appreciated, these kneading disks are relatively narrow, allowing the polymer solution to flow around the flight tips, resulting in the stream splitting and recombining numerous times. With an offset angle of 40°≦θ≦50°, more forward conveying ability and less reverse conveying ability exists than for an offset angle θ of 60°.

It is interesting to note that, in the case of a dispersion stage disclosed herein, designed for preparing a polymeric solution, the discontinuous kneading segments described above provide dispersion utility, rather than distribution and stirring utility. This is contrary to their utility when employed in a system designed to prepare a melt-blended polymer, wherein a continuous flight kneading segment would be utilized for dispersion and a discontinuous kneading segment utilized for distribution and stirring. Importantly, the discontinuous kneading segments described above permit reverse polymer or polymer solution flow, but do not permit the reverse flow of the solvent or diluent introduced within the dispersion stage.

Referring again to FIG. 3, a plurality of extruder screw segments is provided to form first mixing stage 300. As shown in FIG. 1, first mixing stage 300 follows dispersion stage 200 and terminates at second mixing stage 400. As shown in FIG. 3, in one form, first mixing stage 300 includes a plurality of gear kneading segments 302. In another form, first mixing stage 300 includes seven gear kneading segments 302, each having a length of 1.50 D, for a total length of 10.50 D. In one form, first mixing stage 300 has a length Lₘ₁ of about 15% L≦Lₘ₁≦ about 35% L, where L is the total length of extruder shaft 34.

In one form, each gear kneading segment 302 includes a plurality of multi-tooth disks, each multi-tooth disks including 12 gear teeth. In another form, each gear kneading segment 302 includes a five multi-tooth disks.

Referring still to FIG. 3, a plurality of extruder screw segments is provided to form second mixing stage 400. As shown in FIG. 1, second mixing stage 400 follows first mixing stage 300, terminates at outlet stage 500 and is positioned so as to receive a liquid solvent from second fluid inlet 34 for mixing with the polymer solution formed within dispersion stage 200 and first mixing stage 300. As shown in FIG. 3, in one form, second mixing stage 400 includes a plurality of pre-kneading segments 402. In one form, four pre-kneading segments 402 are employed, each have a length of 1.00 D, for a total length of 4.00 D. Second mixing stage 400 also includes a plurality of gear kneading segments 404 and a plurality of neutral kneading segments 406. In one form, second mixing stage 400 includes three gear kneading segments 404, each having a length of 1.50 D, for a total length of 4.50 D. Second mixing stage 400 also includes, in one form, two neutral kneading segments 406, each having a length of 0.50 D, for a total length of 1.00 D. In one form, second mixing stage 400 has a length Lₘ₂ of about 0% L≦Lₘ₂≦ about 30% L, where L is the total length of extruder shaft 34.

In one form, each gear kneading segment 404 includes a plurality of multi-tooth disks, each multi-tooth disks including 12 gear teeth. In another form, each gear kneading segment 404 includes six multi-tooth disks. In one form, each neutral kneading segment 406 includes a plurality of dual flight kneading disks. As is conventional, each dual flight kneading disk is progressively offset by a 90° angle.

Referring again to FIG. 3, a plurality of extruder screw segments is provided to form outlet stage 500. As shown in FIG. 1, outlet stage 500 follows second mixing stage 400, terminates at outlet end 20 and is positioned so as to permit venting from at least one vent 36. Optionally, recycled fluff may be introduced at fluff feed inlet 38. As shown in FIG. 3, in one form, outlet stage 500 includes a pair of first forward full flight screw segment 502, and a second forward full flight screw segments 504. In one form, each first forward full flight screw segment 502 has a length of 1.5 D, for a total length of 3.00 D. Second forward full flight screw segment 504 has a length of 1.00 D.

In one form, when recycled fluff in introduced, outlet stage 500 further includes a second kneading stage 520. Second kneading stage 520 may include a pair of forward kneading segments 506, each have a length of 1.00 D, for a total length of 2.00 D. Following the pair of forward kneading segments 506 is a neutral kneading segment 508 having a length of 1.00 D. Second kneading stage 520 also includes a back kneading segment 510 having a length of 0.50 D. Back kneading segment 510 includes a plurality of kneading disks, each adjacent flight tip of the plurality of kneading disks progressively offset by an angle θ, wherein 0°<θ<−90° or angle θ may equal about −45°. In the event no recycled fluff is employed, a plurality of forward full flight screw segments (not shown) may be substituted for second kneading stage 520, wherein the plurality of forward full flight screw segments has a total length of 3.50 D.

As shown in FIG. 3, following second kneading stage 520, or following a plurality of forward full flight screw segments (not shown), outlet stage 500, includes a pair of third forward full flight screw segment 512, and a fourth forward full flight screw segments 514. In one form, each third forward full flight screw segment 512 is the same as first forward full flight screw segment 502 and has a length of 1.5 D, for a total length of 3.00 D. Likewise, fourth forward full flight screw segments 514 may be the same as second forward full flight screw segment 504, having a length of 1.00 D. Finally, outlet stage 500 may terminate in a plurality of fifth forward full flight screw segments 516, each fifth forward full flight screw segment having a length of 0.75 D, for a total length of 2.25 D. In one form, outlet stage 500 has a length Lₒ of about 0% L≦Lₒ≦ about 40% L, where L is the total length of extruder shaft 34.

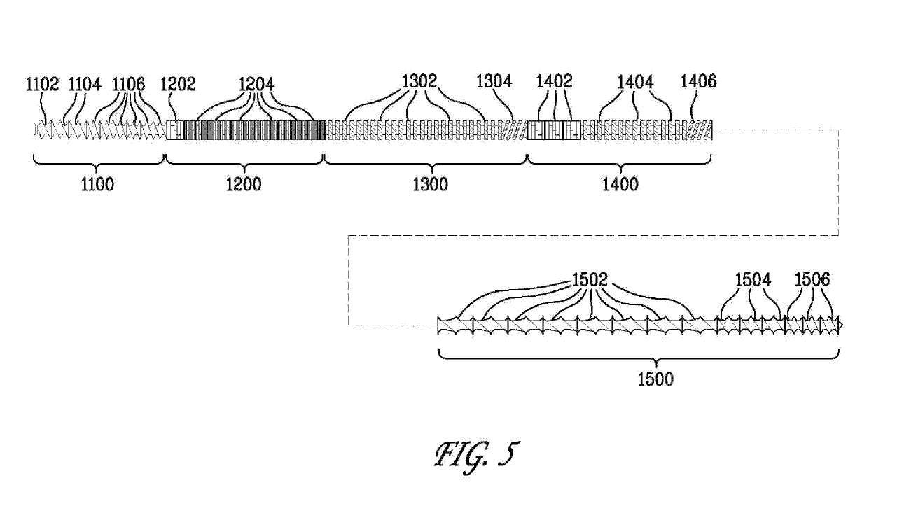

In another form, a plurality of extruder screw segments is shown in FIG. 5. The plurality of extruder screw segments shown are selected to form multiple extruder stages. In one form, the multiple extruder stages include an inlet stage 1100, a dispersion stage 1200, a first mixing stage 1300, a second mixing stage 1400, and an outlet stage 1500. Each stage will now be described with reference to FIG. 5.

A plurality of extruder screw segments is provided to form inlet stage 1100. Referring generally to FIG. 1, inlet stage 1100 initiates near first end 18, terminates at dispersion stage 1200 and is positioned so as to receive thermoplastic material from inlet 24 for processing. As shown in FIG. 5, in one form, inlet stage 1100 includes a first forward full flight screw segment 1102, a pair of second forward full flight screw segments 1104, and six third forward full flight screw segments 1106. In one form, first forward full flight screw segment 1102 has a length of 0.75 X extruder screw diameter “D.” Second forward full flight screw segment 1104 has a length of 1.00 D, for a total length of 2.00 D for the pair. Third forward full flight screw segment 106 also has a length of 0.75 D, for a total length of 4.50 D. In one form, third forward full flight screw segment 1106 has a shorter pitch than the pair of second forward full flight screw segments 1104. In one form, inlet stage 1100 has a length Lᵢ of about 10% L≦Lᵢ≦ about 55% L, where L is the total length of the extruder shaft.

Referring still to FIG. 5, a plurality of extruder screw segments is provided to form dispersion stage 1200. As shown in FIG. 1, dispersion stage 1200 follows inlet stage 1100, terminates at first mixing stage 1300 and is positioned so as to receive a liquid solvent from first fluid inlet 32 for mixing with the thermoplastic material introduced at inlet stage 1100. As shown in FIG. 5, in one form, dispersion stage 1200 includes a pre-kneading segment 1202, and six kneading segments 1204. In one form, the ability of pre-kneading segment 1202 to the move material forward is lower than that of third forward full flight screw segment 1106. In one form, pre-kneading segment 1202 has a length of 1.00 D. Kneading segment 1204 has a length of 1.50 D, for a total length of 9.00 D for the six kneading segments 1204. In one form, dispersion stage 1200 has a length Lᵢ of about 15% L≦Lᵢ≦ about 25% L, where L is the total length of the extruder shaft.

Kneading segment 1204 may be the same or similar to first kneading segment 204, depicted in FIGS. 4A and 4B. Kneading segment 1204 includes a plurality of kneading disks, wherein each adjacent flight tip of each kneading disk is progressively offset by an angle θ, wherein 0°<θ<90° or angle θ may equal about 45°. In another form, the number of kneading disks is greater than 10 and is selected to achieve an offset angle between a flight tip of a last kneading disk of one kneading segment 1204 and a flight tip of a first kneading disk of an adjacent kneading segment 1204 is equal to about 0°. In yet another form, the number of kneading disks and angle θ are selected to enable an adjacent kneading segment 1204 to be positioned to achieve an offset angle between a flight tip of a last kneading disk of a kneading segment 1204 and a flight tip of a first kneading disk of an adjacent kneading segment 1204 substantially equivalent to the angle θ.

In one form, the pair of elongated extruder shafts 34 each have a hexagonal cross section and the offset angle θ is defined as 40°≦θ≦50°. In another form, angle θ is equal to about 45°. In yet another form, the number of kneading disks of kneading segment 1204 is greater than 15. In still yet another form, the number of kneading disks of kneading segment 1204 is 17 and the offset angle between a flight tip of a last kneading disk of the one kneading segment 1204 and a flight tip of a first kneading disk of an adjacent kneading segment is equal to about 0°. As may be appreciated, the greater the number of kneading disks of the kneading segment 1204, the more efficient the dispersion. Also the thinner the disk thickness is, the more efficient the dispersion. With an offset angle of 40°≦θ≦50°, more forward conveying ability and less reverse conveying ability exists than for an offset angle θ of 60°.

Referring again to FIG. 5, a plurality of extruder screw segments is provided to form first mixing stage 1300. As shown in FIG. 1, first mixing stage 1300 follows dispersion stage 1200 and terminates at second mixing stage 1400. As shown in FIG. 5, in one form, first mixing stage 1300 includes a plurality of gear kneading segments 1302. In another form, first mixing stage 1300 includes five gear kneading segments 1302, each having a length of 1.50 D, for a total length of 7.50 D. In one form, each gear kneading segment 1302 includes a plurality of multi-tooth disks, each multi-tooth disks including 12 gear teeth. In another form, each gear kneading segment 1302 includes a five multi-tooth disks.

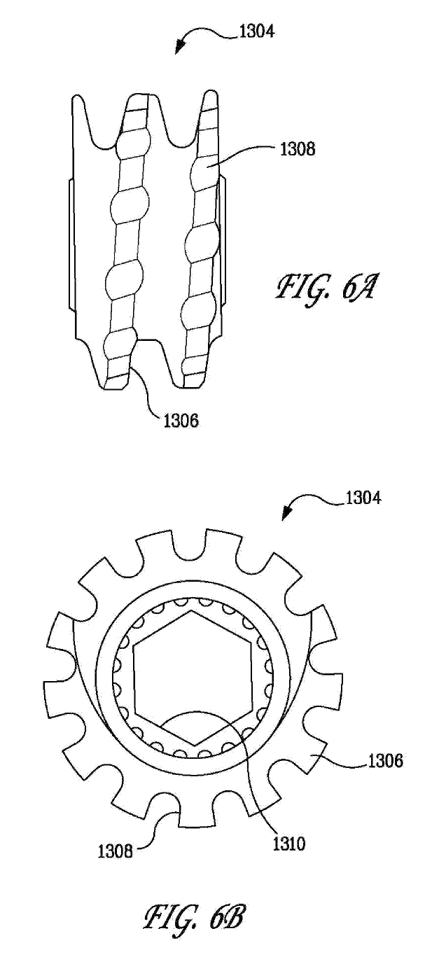

Following the plurality of gear kneading segments 1302 is a reverse mixing screw segment 1304. Reverse mixing screw segment 1304 may have a length ranging from about 0.50 D to about 1.50 D. A form of mixer screw segment 1304 having a length of 0.50 D is shown in detail in FIGS. 6A and 6B. Reverse mixing screw segment 1304 includes a helical flight 1306 which traverses and forms an outer periphery thereof. As shown in FIG. 6B, a plurality of notches 1308 are formed along helical flight 1306, giving the appearance of a sprocket-like device. As shown, helical flight 1306 may be formed to have a reverse flight to promote backwards mixing of the polymer solution. For every 360° of traversal of helical flight 1306, about 10 to about 30 notches 1308 may be provided. While a reverse mixing screw segment 1304 is shown, it is understood by those skilled in the art that the mixer screw segment disclosed herein may also be of a forward or neutral design, as well, depending upon the mixing effect desired. Reverse mixing screw segment 1304 is provided with a means for mounting 1310 reverse mixing screw segment 1304 in a fixed angular relationship on extruder shaft 34.

Advantageously, reverse mixing screw segment 1304 may be used to lengthen the retention time within the first mixing stage 1300 to enhance shearing action. This minimizes the impact on the polymer solution of exposure to high temperatures, which would otherwise be experienced were a conventional reverse mixing segment or neutral mixing (cross) segment used. Since those conventional segments do not have the ability to move the polymer solution forward, the temperature increase inherent with those conventional segments tends to limit the rotation speed and output of the extruder. Another benefit of using reverse mixing screw segment 1304 is that the first mixing stage 1300 can be shortened, reducing polyolefin deterioration due to a reduction in thermal and shear history. As such, in one form, first mixing stage 1300 has a length of Lₘ₁ about 10% L≦Lₘ₁≦ about 20% L, where L is the total length of the extruder shaft.

Referring again to FIG. 5, a plurality of extruder screw segments is provided to form second mixing stage 1400. As shown generally in FIG. 1, second mixing stage 1400 follows first mixing stage 1300, terminates at outlet stage 1500 and is positioned so as to receive a liquid solvent from second fluid inlet 33 for mixing with the polymer-diluent mixture, e.g., the polymer solution, formed within dispersion stage 1200 and first mixing stage 1300. As shown in FIG. 5, in one form, second mixing stage 1400 includes three pre-kneading segments 1402 are employed, each have a length of 1.00 D, for a total length of 3.00 D. Second mixing stage 1400 also includes a plurality of gear kneading segments 1404. In one form, second mixing stage 1400 includes three gear kneading segments 1404, each having a length of 1.50 D, for a total length of 4.50 D.

Following the plurality of gear kneading segments 1404 is a reverse mixing screw segment 1406. Reverse mixing screw segment 1406 may have a length ranging from about 0.50 D to about 1.50 D. Reverse mixer screw segment 1406 may be the same or similar to the reverse mixing screw segment 1304 shown in detail in FIGS. 6A and 6B. Referring generally to FIGS. 6A and 6B, reverse mixing screw segment 1406 includes a helical flight which traverses and forms an outer periphery thereof. A plurality of notches is formed along the helical flight, giving reverse mixing screw segment 1406 the appearance of a sprocket-like device. The helical flight may be formed to have a reverse flight to promote backwards mixing of the polymer-diluent mixture. For every 360° of traversal of the helical flight about 10 to about 30 notches may be provided. It is understood by those skilled in the art that the mixer screw segment may also have a forward or neutral design, depending upon the mixing effect desired. Reverse mixing screw segment 1406 is provided with a means for mounting reverse mixing screw segment 1406 in a fixed angular relationship on the extruder shaft.

Reverse mixing screw segment 1406 may also be used to lengthen the retention time within second mixing stage 1400 to enhance shearing action. This minimizes the impact on the polymer solution of exposure to high temperatures, which would otherwise be experienced were a conventional reverse mixing segment or neutral mixing (cross) segment used. Since those conventional segments do not have the ability to move the polymer solution forward, the temperature increase inherent with those conventional segments tends to limit the rotation speed and output of the extruder. Another benefit of using reverse mixing screw segment 1406 is that the second mixing stage 1400 can be shortened, reducing polyolefin deterioration due to a reduction in thermal and shear history. As such, in one form, second mixing stage 1400 has a length Lₘ₂ of about 0% L≦Lₘ₂≦ about 20% L, where L is the total length of the extruder shaft.

As shown in FIG. 5, a plurality of extruder screw segments is provided to form outlet stage 1500. As shown generally in FIG. 1, outlet stage 1500 follows second mixing stage 1400, terminates at outlet end 20 and is positioned so as to permit venting from at least one vent 36. As shown in FIG. 5, in one form, outlet stage 1500 includes eight first forward full flight screw segment 1502, three second forward full flight screw segments 1504 and three third forward full flight screw segments 1506. In one form, each first forward full flight screw segment 1502 has a length of 1.5 D, for a total length of 12.00 D. Each second forward full flight screw segment 1504 has a length of 1.00 D, for a total length of 3.00 D. Each third forward full flight screw segment 1506 has a length of 0.75 D, for a total length of 2.25 D. In one form, outlet stage 1500 has a length Lₒ of about 0% L≦Lₒ≦ about 40% L, where L is the total length of the extruder shaft.

In another form, a reverse mixing screw segment may be added to the dispersion stage 1200. Such a reverse mixing segment may have a length ranging from about 0.50 D to about 1.50 D. A form of such a mixer screw segment having a length of 0.50 D is shown in detail in FIGS. 6A and 6B and has been described hereinabove. When used within dispersion stage 1200, an increase in stage length may be required to avoid the backflow of the solvent or diluent injected into that stage.

In another form, provided is a process for extruding a polymer-diluent mixture, e.g., a polymeric solution. The process includes the steps of blending at least one polymer at a rate of P grams per second in an inlet stage 1100 and conducting the blended polymer to a dispersion stage 1200. At least one diluent (e.g., a solvent) is introduced to the blended polymer in the dispersion stage 1200 at a rate of S grams per second, the diluent having a lower viscosity than the polymer. The diluent is then dispersed in the polymer and conducted to a first mixing stage 1300. In the first mixing stage 1300, solvent and the polymer is blended in order to produce a third-stage product, the third stage product comprising (i) the polymer-diluent mixture in a first phase, (ii) a portion of the diluent in a second phase separate from the first phase, and (iii) a portion of the polymer in a third phase separate from the first and second phases. In one form, the mixing energy in the first mixing stage 1300 is greater than the mixing energy in either the inlet stage 1100 or dispersion stage 1200.

In one form, the first phase is produced at a rate of R grams per second, with R being about 0.9×(P+S) or greater, the second phase is produced at a rate that does not exceed 0.05×S, and the third phase is produced at a rate that does not exceed 0.05×P. In another form, rate of countercurrent diluent flow from the dispersion stage to the inlet stage 1100 does not exceed 0.1×S.

In another form, a major portion of the polymer is a first polyethylene, having a molecular weight in the range of from 1.0×10⁴ to 5×10⁵ and a second polyethylene, having a molecular weight in the range of from 5.0×10⁵ to 5.0×10⁶. In yet another form, the polymer further comprises polypropylene having a molecular weight in the range of from 3.0×10⁵ to 3.0×10⁶. In one form, the first polyethylene is present in the polymer in an amount in the range of from 0 to 100%, the second polyethylene is present in the polymer in an amount in the range of from 0 to 100%, and the polypropylene is in the polymer in an amount in the range of from 0 to 70%. In another form, the solvent is liquid paraffin, P is from 3 to 15, and R= is from 7 to 40.

In one form the mixing energy in the inlet stage 1100 and dispersion stage 1200 is lower than the first mixing stage 1300. The process conditions in the inlet stage 1100 is characterized by a temperature set to 150° C., P=10, a pressure less than 5 kg/cm², and a residence time of 18 seconds, and the dispersion stage 1200 is characterized by a temperature of 200° C., S=23, a pressure of less than 5 kg/cm², and a residence time of 14 seconds. In another form, the mixing energy is obtained from at least one segmented mixing screw extending continuously in the direction of polymer flow through the inlet stage 1100 and the dispersion stage 1200.

The extruder forms disclosed herein find utility in the extrusion and production of microporous films and sheets. These films and sheets find particular utility in the critical field of battery separators. The multi-layer films and sheets described hereinbelow can either be produced using a coextrusion die or be produced using a monolayer die to produce a monolayer film or sheet, with additional layers laminated thereto in a conventional manner.

In one form, the multi-layer, microporous membrane comprises two layers. The first layer (e.g., the skin, top or upper layer of the membrane) comprises a first microporous layer material, and the second layer (e.g., the bottom or lower or core layer of the membrane) comprises a second microporous layer material. For example, the membrane can have a planar top layer when viewed from above on an axis approximately perpendicular to the transverse and longitudinal (machine) directions of the membrane, with the bottom planar layer hidden from view by the top layer.

In another form, the multi-layer, microporous membrane comprises three or more layers, wherein the outer layers (also called the “surface” or “skin” layers) comprise the first microporous layer material and at least one core or intermediate layer comprises the second microporous layer material. In a related form, where the multi-layer, microporous membrane comprises two layers, the first layer consists essentially of the first microporous layer material and the second layer consists essentially of the second microporous layer material. In a related form where the multi-layer, microporous membrane comprises three or more layers, the outer layers consist essentially of the first microporous layer material and at least one intermediate layer consists essentially of (or consists of) the second microporous layer material.

Starting materials having utility in the production of the afore-mentioned films and sheets will now be described. As will be appreciated by those skilled in the art, the selection of a starting material is not critical. In one form, the first and second microporous layer materials contain polyethylene. In one form, the first microporous layer material contains a first polyethylene (“PE-1”) having an Mw value of less than about 1×10⁶ or a second polyethylene (“UHMWPE-1”) having an Mw value of at least about 1×10⁶. In one form, the first microporous layer material can contain a first polypropylene (“PP-1”). In one form, the first microporous layer material comprises one of (i) a polyethylene (PE), (ii) an ultra high molecular weight polyethylene (UHMWPE), (iii) PE-1 and PP-1, or (iv) PE-1, UHMWPE-1, and PP-1.

In one form of the above (ii) and (iv), UHMWPE-1 can preferably have an Mw in the range of from about 1×10⁶ to about 15×10⁶ or from about 1×10⁶ to about 5×10⁶ or from about 1×10⁶ to about 3×10⁶, and preferably contain greater than about 1 wt. %, or about 15 wt. % to 40 wt. %, on the basis of total amount of PE-1 and UHMWPE-1 in order to obtain a microporous layer having a hybrid structure defined in the later section, and can be at least one of homopolymer or copolymer. In one form of the above (iii) and (iv), PP-1 can be at least one of a homopolymer or copolymer, or can preferably contain no more than about 25 wt. %, on the basis of total amount of the first layer microporous material. In one form, the Mw of polyolefin in the first microporous layer material can have about 1×10⁶ or less, or in the range of from about 1×10⁵ to about 1×10⁶ or from about 2×10⁵ to about 1×10⁶ in order to obtain a microporous layer having a hybrid structure defined in the later section. In one form, PE-1 can preferably have an Mw ranging from about 1×10⁴ to about 5×10⁵, or from about 2×10⁵ to about 4×10⁵, and can be one or more of a high-density polyethylene, a medium-density polyethylene, a branched low-density polyethylene, or a linear low-density polyethylene, and can be at least one of a homopolymer or copolymer.

In one form, the first microporous layer material (the first layer of the two-layer, microporous membrane and the first and third layers of a three-layer microporous membrane) has a hybrid structure, which is characterized by a pore size distribution exhibiting relatively dense domains having a main peak in a range of 0.01 μm to 0.08 μm and relatively coarse domains exhibiting at least one sub-peak in a range of more than 0.08 μm to 1.5 μm or less in the pore size distribution curve. The ratio of the pore volume of the dense domains (calculated from the main peak) to the pore volume of the coarse domains (calculated from the sub-peak) is not critical, and can range, e.g., from about 0.5 to about 49.

In one form, the second microporous layer material comprises one of: (i) a fourth polyethylene having an Mw of at least about 1×10⁶, (UHMWPE-2), (ii) a third polyethylene having an Mw that is less than 1×10⁶ and UHMWPE-2 and the fourth polyethylene, wherein the fourth polyethylene is present in an amount of at least about 8% by mass based on the combined mass of the third and fourth polyethylene; (iii) UHMWPE-2 and PP-2, or (iv) PE-2, UHMWPE-2, and PP-2. In one form of the above (ii), (iii) and (iv), UHMWPE-2 can contain at least about 8 wt. %, or at least about 20 wt. %, or at least about 25 wt. %, based on the total amount of UHMWPE-2, PE-2 and PP-2 in order to produce a relatively strong multi-layer, microporous membrane. In one form of the above (iii) and (iv), PP-2 can be at least one of a homopolymer or copolymer, and can contain 50 wt. % or less, 35 wt. % or less, 25 wt. % or less, or in the range of from about 2% to about 50%, of from about 2% to about 15%, or from about 3% to about 10%, based on the total amount of the second microporous layer material. In one form, preferable PE-2 can be the same as PE-1, but can be selected independently. In one form, preferable UHMWPE-2 can be the same as UHMWPE-1, but can be selected independently.

In addition to the first, second, third, and fourth polyethylenes and the first and second polypropylenes, each of the first and second layer materials can optionally contain one or more additional polyolefins, identified as the seventh polyolefin, which can be, e.g., one or more of polybutene-1, polypentene-1, poly-4-methylpentene-1, polyhexene-1, polyoctene-1, polyvinyl acetate, polymethyl methacrylate, polystyrene and an ethylene α-olefin copolymer (except for an ethylene-propylene copolymer) and can have an Mw in the range of about 1×10⁴ to about 4×10⁶. In addition to or besides the seventh polyolefin, the first and second microporous layer materials can further comprise a polyethylene wax, e.g., one having an Mw in the range of about 1×10³ to about 1×10⁴.

In one form, a process for producing a two-layer microporous membrane is provided. In another form, the microporous membrane has at least three layers. For the sake of brevity, the production of the microporous membrane will be mainly described in terms of two-layer and three-layer membrane.

In one form, a three-layer microporous membrane comprises first and third microporous layers constituting the outer layers of the microporous membrane and a second (core) layer situated between (and optionally in planar contact with) the first and third layers. In another form, the first and third layers are produced from a first mixture of polymer and diluent and the second (core) layer is produced from a second mixture of polymer and diluent.

In one form, a method for producing the multi-layer, microporous membrane is provided. The method comprises the steps of (1) combining (e.g., by blending) a first polymeric composition and at least one diluent (e.g., a membrane-forming solvent) to prepare a first mixture in an extruder of the type disclosed herein, (2) combining a second polymeric composition and at least one second diluent (e.g., a second membrane-forming solvent) to prepare a second mixture in an extruder of the type disclosed herein, (3) extruding the first mixture through a first die and the second mixture through a second die and then laminating the extruded first and second mixtures to form a multi-layer extrudate, (4) cooling the multi-layer extrudate to form a multi-layer, gel-like sheet (cooled extrudate), (5) removing the membrane-forming solvent from the multi-layer, gel-like sheet to form a solvent-removed gel-like sheet, and (6) drying the solvent-removed gel-like sheet in order to form the multi-layer, microporous membrane. An optional stretching step (7), and an optional hot solvent treatment step (8) can be conducted between steps (4) and (5), if desired. After step (6), an optional step (9) of stretching a multi-layer, microporous membrane, an optional heat treatment step (10), an optional cross-linking step with ionizing radiations (11), and an optional hydrophilic treatment step (12), etc., can be conducted.

The first polyolefin composition comprises polyolefin resins as described above that can be combined, e.g., by dry mixing or blending with an appropriate membrane-forming solvent to produce the first polyolefin solution. Optionally, the first mixture can contain various additives such as one or more antioxidant, fine silicate powder (pore-forming material), etc., provided these are used in a concentration range that does not significantly degrade the desired properties of the multi-layer, microporous membrane.

The first membrane-forming solvent is preferably a solvent that is liquid at room temperature. While not wishing to be bound by any theory or model, it is believed that the use of a liquid solvent to form the first polyolefin solution makes it possible to conduct stretching of the gel-like sheet at a relatively high stretching magnification. In one form, the first membrane-forming solvent can be at least one of aliphatic, alicyclic or aromatic hydrocarbons such as nonane, decane, decalin, p-xylene, undecane, dodecane, liquid paraffin, etc.; mineral oil distillates having boiling points comparable to those of the above hydrocarbons; and phthalates liquid at room temperature such as dibutyl phthalate, dioctyl phthalate, etc. In one form where it is desired to obtain a multi-layer, gel-like sheet having a stable liquid solvent content, non-volatile liquid solvents such as liquid paraffin can be used, either alone or in combination with other solvents. Optionally, a solvent which is miscible with polyethylene in a blended state but solid at room temperature can be used, either alone or in combination with a liquid solvent. Such solid solvent can include, e.g., stearyl alcohol, ceryl alcohol, paraffin waxes, etc.

The viscosity of the liquid solvent is not a critical parameter. For example, the viscosity of the liquid solvent can range from about 30 cSt to about 500 cSt, or from about 30 cSt to about 200 cSt, at 25° C. Although it is not a critical parameter, when the viscosity at 25° C. is less than about 30 cSt, it can be more difficult to prevent foaming the polyolefin solution, which can lead to difficulty in blending. On the other hand, when the viscosity is greater than about 500 cSt, it can be more difficult to remove the liquid solvent from the multi-layer microporous membrane.

In one form, the resins, etc., used to produce to the first polyolefin composition are blended in, e.g., a double screw extruder or mixer. For example, a conventional extruder (or mixer or mixer-extruder) such as a double-screw extruder can be used to combine the resins, etc., to form the first polyolefin composition. The membrane-forming solvent can be added to the polyolefin composition (or alternatively to the resins used to produce the polyolefin composition) at any convenient point in the process. For example, in one form where the first polyolefin composition and the first membrane-forming solvent are blended, the solvent can be added to the polyolefin composition (or its components) at any of (i) before the start of blending, (ii) during blending of the first polyolefin composition, or (iii) after blending, e.g., by supplying the first membrane-forming solvent to the blended or partially blended polyolefin composition in a second extruder or extruder zone located downstream of the extruder zone used to blend the polyolefin composition.

When an extruder of the type disclosed herein is employed, the screw can be characterized by a ratio L/D of the screw length L to the screw diameter D in the double-screw extruder, which can range, for example, from about 20 to about 200 or from about 25 to about 100. Although this parameter is not critical, when L/D is less than about 20, blending can be more difficult, and when L/D is more than about 100, faster extruder speeds might be needed to prevent excessive residence time of the polyolefin solution in the double-screw extruder, which can lead to undesirable molecular weight degradation. Although it is not a critical parameter, the cylinder (or bore) of the double-screw extruder can have an inner diameter of in the range of about 40 mm to about 100 mm, for example.

The amount of the first polyolefin composition in the first mixture is not critical. In one form, the amount of first polyolefin composition in the first mixture can range from about 1 wt. % to about 75 wt. %, based on the weight of the mixture, for example from about 20 wt. % to about 70 wt. %.

The second mixture can be prepared by the same methods used to prepare the first mixture. For example, the second mixture can be prepared by blending a second polyolefin composition with a second membrane-forming solvent.

The amount of the second polyolefin composition in the second mixture is not critical. In one form, the amount of second polyolefin composition in the second mixture can range from about 1 wt. % to about 75 wt. %, based on the weight of the second mixture, for example from about 20 wt. % to about 70 wt. %.

A monolayer extrusion die may be used to form an extrudate that can be laminated. In one form, extrusion dies, which can be adjacent or connected, are used to form the extrudates. The first and second sheet dies are connected to first and second extruders, respectively, where the first extruder contains the first mixture and the second extruder contains the second mixture. While not critical, lamination is generally easier to accomplish when the extruded first and second polyolefin solution are still at approximately the extrusion temperature.

In another form, first, second, and third dies are connected to first, second and third extruders of the type disclosed herein, where the first and third dies contain the first mixture, and the second die contains the second mixture. In this form, a laminated extrudate is formed constituting outer layers comprising the extruded first mixture and one intermediate comprising the extruded second mixture.

In yet another form, the first, second, and third dies are connected to first, second, and third extruders of the type disclosed herein, where the second die contains the first mixture, and the first and third dies contain the second mixture. In this form, a laminated extrudate is formed constituting outer layers comprising the extruded second mixture and one intermediate comprising extruded first mixture.

The die gaps are generally not critical. For example, extrusion dies can have a die gap of about 0.1 mm to about 5 mm. Die temperature and extruding speed are also non-critical parameters. For example, the dies can be heated to a die temperature ranging from about 140° C. to about 250° C. during extrusion. The extruding speed can range, for example, from about 0.2 m/minute to about 15 m/minute. The thickness of the layers of the layered extrudate can be independently selected. For example, the resultant sheet can have relatively thick skin or surface layers compared to the thickness of an intermediate layer of the layered extrudate.

A cooled extrudate, e.g., a multi-layer, gel-like sheet can be obtained by cooling, for example. Cooling rate and cooling temperature are not particularly critical. For example, the multi-layer, gel-like sheet can be cooled at a cooling rate of at least about 50° C./minute until the temperature of the multi-layer, gel-like sheet (the cooling temperature) is approximately equal to the multi-layer, gel-like sheet's gelatin temperature (or lower). In one form, the extrudate is cooled to a temperature of about 25° C. or lower in order to form the multi-layer gel-like sheet.

In one form, the first and second membrane-forming solvents are removed (or displaced) from the multi-layer gel-like sheet in order to form a solvent-removed gel-like sheet. A displacing (or “washing”) solvent can be used to remove (wash away, or displace) the first and second membrane-forming solvents. The choice of washing solvent is not critical provided it is capable of dissolving or displacing at least a portion of the first and/or second membrane-forming solvent. Suitable washing solvents include, for instance, one or more of volatile solvents such as saturated hydrocarbons such as pentane, hexane, heptane, etc.; chlorinated hydrocarbons such as methylene chloride, carbon tetrachloride, etc.; ethers such as diethyl ether, dioxane, etc.; ketones such as methyl ethyl ketone, etc.; linear fluorocarbons such as trifluoroethane, C₆F₁₄, C₇F₁₆, etc.; cyclic hydrofluorocarbons such as C₅H₃F₇, etc.; hydrofluoroethers such as C₄F₉OCH₃, C₄F₉OC₂H₅, etc.; and perfluoroethers such as C₄F₉OCF₃, C₄F₉OC₂H₅, etc.

The method for removing the membrane-forming solvent is not critical, and any method capable of removing a significant amount of solvent can be used, including conventional solvent-removal methods. For example, the multi-layer, gel-like sheet can be washed by immersing the sheet in the washing solvent and/or showering the sheet with the washing solvent. The amount of washing solvent used is not critical, and will generally depend on the method selected for removal of the membrane-forming solvent. In one form, the membrane-forming solvent is removed from the gel-like sheet (e.g., by washing) until the amount of the remaining membrane-forming solvent in the multi-layer gel-like sheet becomes less than 1 wt. %, based on the weight of the gel-like sheet.

In one form, the solvent-removed multi-layer, gel-like sheet obtained by removing the membrane-forming solvent is dried in order to remove the washing solvent. Any method capable of removing the washing solvent can be used, including conventional methods such as heat-drying, wind-drying (moving air), etc. The temperature of the gel-like sheet during drying (i.e., drying temperature) is not critical. For example, the drying temperature can be equal to or lower than the crystal dispersion temperature Tcd. Tcd is the lower of the crystal dispersion temperature Tcd₁ of the polyethylene in the first resin and the crystal dispersion temperature Tcd₂ of the polyethylene in the second resin. For example, the drying temperature can be at least 5° C. below the crystal dispersion temperature Tcd. The crystal dispersion temperature of the polyethylene in the first and second resins can be determined by measuring the temperature characteristics of the kinetic viscoelasticity of the polyethylene according to ASTM D 4065. In one form, the polyethylene in at least one of the first or second resins has a crystal dispersion temperature in the range of about 90° C. to about 100° C.

Although it is not critical, drying can be conducted until the amount of remaining washing solvent is about 5 wt. % or less on a dry basis, i.e., based on the weight of the dry multi-layer, microporous membrane. In another form, drying is conducted until the amount of remaining washing solvent is about 3 wt. % or less on a dry basis.

Prior to the step for removing the membrane-forming solvents, the multi-layer, gel-like sheet can be stretched in order to obtain a stretched, multi-layer, gel-like sheet.

Neither the choice of stretching method nor the degree of stretching magnification is particularly critical. In one form, the stretching can be accomplished by one or more of tenter-stretching, roller-stretching, or inflation stretching (e.g., with air). Although the choice is not critical, the stretching can be conducted monoaxially (i.e., in either the machine or transverse direction) or biaxially (both the machine and transverse direction). In the case of biaxial stretching (also called biaxial orientation), the stretching can be simultaneous biaxial stretching, sequential stretching along one planar axis and then the other (e.g., first in the transverse direction and then in the machine direction), or multi-stage stretching (for instance, a combination of the simultaneous biaxial stretching and the sequential stretching).

The stretching magnification is not critical. In a form where monoaxial stretching is used, the linear stretching magnification can be, e.g., about 2 fold or more, or about 3 to about 30 fold. In a form where biaxial stretching is used, the linear stretching magnification can be, e.g., about 3 fold or more in any lateral direction. In another form, the linear magnification resulting from stretching is at least about 9 fold, or at least about 16 fold, or at least about 25 fold in area magnification.

The temperature of the multi-layer, gel-like sheet during stretching (namely the stretching temperature) is not critical. In one form, the temperature of the gel-like sheet during stretching can be about (Tm+10° C.) or lower, or optionally in a range that is higher than Tcd but lower than Tm, wherein Tm is the lesser of the melting point Tm₁ of the polyethylene in the first resin and the melting point Tm₂ of the polyethylene in the second resin.

The stretching when used generally makes it easier to produce a relatively high-mechanical strength multi-layer, microporous membrane with a relatively large pore size. Such multi-layer, microporous membranes are believed to be particularly suitable for use as battery separators.

Optionally, stretching can be conducted in the presence of a temperature gradient in a thickness direction (i.e., a direction approximately perpendicular to the planar surface of the multi-layer, microporous membrane) as described in JP 3,347,854 B2. In this case, it can be easier to produce a multi-layer, microporous membrane with improved mechanical strength.

Although it is not required, the multi-layer, gel-like sheet can be treated with a hot solvent. When used, it is believed that the hot solvent treatment provides the fibrils (such as those formed by stretching the multi-layer gel-like sheet) with a relatively thick leaf-vein-like structure. The details of this method are described in WO 2000/20493.

In one form, the dried multi-layer, microporous membrane can be stretched, at least monoaxially. The stretching method selected is not critical, and conventional stretching methods can be used such as by a tenter method, etc. When the multi-layer gel-like sheet has been stretched as described above the stretching of the dry multi-layer, microporous membrane can be called dry-stretching, re-stretching, or dry-orientation.

The temperature of the dry multi-layer, microporous membrane during stretching (the “dry stretching temperature”) is not critical. In one form, the dry stretching temperature is approximately equal to the melting point Tm or lower, for example in the range of from about the crystal dispersion temperature Tcd to the about the melting point Tm. In one form, the dry stretching temperature ranges from about 90° C. to about 135° C., or from about 95° C. to about 130° C.

When dry-stretching is used, the stretching magnification is not critical. For example, the stretching magnification of the multi-layer, microporous membrane can range from about 1.1 fold to about 2.5 or about 1.1 to about 2.0 fold in at least one lateral (planar) direction.

In one form, the dried multi-layer, microporous membrane can be heat-treated. In one form, the heat treatment comprises heat-setting and/or annealing. When heat-setting is used, it can be conducted using conventional methods such as tenter methods and/or roller methods. Although it is not critical, the temperature of the dried multi-layer, microporous membrane during heat-setting (i.e., the “heat-setting temperature”) can range from the Tcd to about the Tm.

Annealing differs from heat-setting in that it is a heat treatment with no load applied to the multi-layer, microporous membrane. The choice of annealing method is not critical, and it can be conducted, for example, by using a heating chamber with a belt conveyer or an air-floating-type heating chamber. Alternatively, the annealing can be conducted after the heat-setting with the tenter clips slackened. The temperature of the multi-layer, microporous membrane during annealing can range from about the melting point Tm or lower, from about 60° C. to (Tm−10° C.), or in a range of from about 60° C. to (Tm−5° C.).

In one form, the multi-layer, microporous membrane can be cross-linked (e.g., by ionizing radiation rays such as a-rays, (3-rays, 7-rays, electron beams, etc.) or can be subjected to a hydrophilic treatment (i.e., a treatment which makes the multi-layer, microporous membrane more hydrophilic (e.g., a monomer-grafting treatment, a surfactant treatment, a corona-discharging treatment, etc.))).

In another form, a second method for producing the multi-layer, microporous membrane comprises the steps of (1) combining (e.g., by blending) a first polyolefin composition and a membrane-forming solvent to prepare a first polyolefin solution in an extruder of the type disclosed herein, (2) combining a second polyolefin composition and a second membrane-forming solvent to prepare a second polyolefin solution in an extruder of the type disclosed herein, (3) extruding the first polyolefin solution through at least one first die to form at least one first extrudate, (4) extruding the second polyolefin solution through at least one second die to form at least one second extrudate, (5) cooling first and second extrudates to form at least one first gel-like sheet and at least one second gel-like sheet, (6) laminating the first and second gel-like sheet to form a multi-layer, gel-like sheet, (7) removing the membrane-forming solvent from the resultant multi-layer, gel-like sheet to form a solvent-removed gel-like sheet, and (8) drying the solvent-removed gel-like sheet in order to form the multi-layer, microporous membrane. An optional stretching step (9), and an optional hot solvent treatment step (10), etc., can be conducted between steps (5) and (6) or between steps (6) and (7), if desired. After step (8), an optional step (11) of stretching a multi-layer, microporous membrane, an optional heat treatment step (12), an optional cross-linking step with ionizing radiations (13), and an optional hydrophilic treatment step (14), etc., can be conducted.

The main difference between the second production method and the production method described hereinabove is in the order of the steps for laminating and cooling. In the previously described production method, laminating the first and second polyolefin solutions is conducted before the cooling step. In this production method, the first and second polyolefin solutions are cooled before the laminating step.

Steps (1), (2), (7) and (8) in this production method can be the same as the steps of (1), (2), (5) and (6) in the previously described production method. For the extrusion of the first polyolefin solution through the first die, the conditions of step (3) of the first production method can be used for step (3) of the second production method. For the extrusion of the second solution through the second die, the conditions of step (4) in the first production method can be the same as the conditions of step (3) in the second production method. In one form, either the first or second polyolefin solution is extruded through a third die. In this way, a multi-layer laminate can be formed having two layers produced from the first polyolefin solution and a single layer produced from the second polyolefin solution, or vice versa.

Step (5) of this production method can be the same as step (4) in the previously described production method, except that in the second production method the first and second gel-like sheets are formed separately.

Step (6) of laminating the first and second gel-like sheets will now be explained in more detail. The choice of lamination method is not particularly critical, and conventional lamination methods such as heat-induced lamination can be used to laminate the multi-layer gel-like sheet. Other suitable lamination methods include, for example, heat-sealing, impulse-sealing, ultrasonic-bonding, etc., either alone or in combination. Heat-sealing can be conducted using, e.g., one or more pair of heated rollers where the gel-like sheets are conducted through at least one pair of the heated rollers. Although the heat-sealing temperature and pressure are not particularly critical, sufficient heating and pressure should be applied for a sufficient time to ensure that the gel-like sheets are appropriately bonded to provide a multi-layer, microporous membrane with relatively uniform properties and little tendency toward delamination. In one form, the heat-sealing temperature can be, for instance, about 90° C. to about 135° C., or from about 90° C. to about 115° C. In another form, the heat-sealing pressure can be from about 0.01 MPa to about 50 MPa.

As is the case in the first production method, the thickness of the layers formed from the first and second polyolefin solution (i.e., the layers comprising the first and second microporous layer materials) can be controlled by adjusting the thickness of the first and second gel-like sheets and by the amount of stretching (stretching magnification and dry stretching magnification), when one or more stretching steps are used. Optionally, the lamination step can be combined with a stretching step by passing the gel-like sheets through multi-stages of heated rollers.

In one form, the second production method forms a multi-layer, polyolefin gel-like sheet having at least three layers. For example, after cooling, two extruded first polyolefin solutions and one extruded second polyolefin solution to form the gel-like sheets, the multi-layer gel-like sheet can be laminated with outer layers comprising the extruded first polyolefin solution and an intermediate layer comprising the extruded second polyolefin solution. In another form, after cooling two extruded second polyolefin solutions and one extruded first polyolefin solution to form the gel-like sheets, the multi-layer gel-like sheet can be laminated with outer layers comprising the extruded second polyolefin solution and an intermediate layer comprising the extruded first polyolefin solution.

The stretching step (9) and the hot solvent treatment step (10) can be the same as the stretching step (7) and the hot solvent treatment step (8) as described for the first production method, except stretching step (9) and hot solvent treatment step (10) are conducted on the first and/or second gel-like sheets. The stretching temperatures of the first and second gel-like sheets are not critical. For example, the stretching temperatures of the first gel-like sheet can be, e.g., Tm₁+10° C. or lower, or optionally about Tcd₁ or higher but lower than about Tm₁. The stretching temperature of the second gel-like sheet can be, e.g., Tm₂+10° C. or lower, or optionally about Tcd₂ or higher but lower than about Tm₂.

In another form, the stretching temperature of the first gel-like sheet ranges from about the crystal dispersion temperature Tcd₁ of the polyethylene in the first resin to Tcd₁+25° C., or from about Tcd₁+10° C. to Tcd₁+25° C., or from about Tcd₁+15° C. to Tcd₁+25° C. The stretching temperature of the second gel-like sheet ranges from the crystal dispersion temperature Tcd₂ of the polyethylene in the second resin to about Tcd₂+25° C., or about Tcd₂+10° C. to Tcd₂+25° C., or about Tcd₂+15° C. to Tcd₂+25° C.

In yet another form, a third method for producing the multi-layer, microporous membrane comprises the steps of (1) combining (e.g., by blending) a first polyolefin composition and a membrane-forming solvent to prepare a first polyolefin solution in an extruder of the type disclosed herein, (2) combining a second polyolefin composition and a second membrane-forming solvent to prepare a second polyolefin solution in an extruder of the type disclosed herein, (3) extruding the first polyolefin solution through at least one first die to form at least one first extrudate, (4) extruding the second polyolefin solution through at least one second die to form at least one second extrudate, (5) cooling first and second extrudates to form at least one first gel-like sheet and at least one second gel-like sheet, (6) removing the first and second membrane-forming solvents from the first and second gel-like sheets to form solvent-removed first and second gel-like sheets, (7) drying the solvent-removed first and second gel-like sheets to form at least one first polyolefin membrane and at least one second polyolefin membrane, and (8) laminating the first and second microporous membranes in order to form the multi-layer, microporous membrane.

A stretching step (9) and a hot solvent treatment step (10), etc., can be conducted between steps (5) and (6), if desired. A stretching step (11) and a heat treatment step (12), etc., can be conducted between steps (7) and (8), if desired. After step (8), a step (13) of stretching a multi-layer, microporous membrane, a heat treatment step (14), a cross-linking step with ionizing radiations (15) and a hydrophilic treatment step (16), etc., can be conducted if desired.

Steps (1) and (2) in the third production method can be conducted under the same conditions as steps of (1) and (2) in the first production method. Steps (3), (4), and (5) in the third production method can be conducted under the same conditions as steps (3), (4), and (5) in the second method. Step (6) in the third production method can be conducted under the same conditions as step (5) in the first production method except for removing the membrane-forming solvent from the first and second gel-like sheets. Step (7) in the third production method can be conducted under the same conditions as step (6) in the first production method except that in the third production method the first and second solvent-removed gel-like sheets are dried separately. Step (8) in the third production method can be conducted under the same conditions as the step (6) in the second production method except for laminating the first and second polyolefin microporous membranes. The stretching step (9) and the hot solvent treatment step (10) in the third production method can be conducted under the same conditions as step (9) and (10) in the second production method. The stretching step (11) and the heat treatment step (12) in the third production method can be conducted under the same conditions as steps (9) and (10) in the first production method except that in the third production method the first and second polyolefin microporous membranes are stretched and/or heat treated.

In one form, in the stretching step (11) in the third production method, the stretching temperature of the first microporous membrane can be about Tm₁ or lower, or optionally about Tcd₁ to about Tm₁, and the stretching temperature of the second microporous membrane can be about Tm₂ or lower, or optionally about Tcd₂ to about Tm₂.

In one form, the heat treatment step (12) in the third production method can be HS and/or annealing. For example, in the heat treatment step (12) in the third production method, the heat-setting temperature of the first polyolefin microporous membranes can be about Tcd₁ to about Tm₁, or optionally about the dry stretching temperature +5° C., or optionally about the dry stretching temperature ±3° C. In one form, in the heat treatment step (12) in the third production method, the heat-setting temperature of the second microporous membrane can be about Tcd₂ to about Tm₂, or optionally the dry stretching temperature ±5° C., or optionally the dry stretching temperature ±3° C. When the HS is used, it can be conducted by, e.g., a tenter method or a roller method.

In one form, in the heat treatment step (12) in the third production method, the annealing temperature of the first microporous membrane can be about Tm₁ or lower, or optionally about 60° C. to about (Tm₁−10° C.). In one form, in the heat treatment step (12) in the third production method, the annealing temperature of the second microporous membranes can be about Tm₂ or lower, or optionally about 60° C. to about (Tm₂−10° C.).

The conditions in step (13), stretching a multi-layer, microporous membrane, a heat treatment step (14), a cross-linking step with ionizing radiations (15), and a hydrophilic treatment step (16) in the third production method can be the same as those for steps (9), (10), (11) and (12) in the first production method.

In still yet another form, a fourth production method for producing a multi-layer, microporous membrane is provided. The method comprises the steps of (1) combining (e.g., by blending) a first polyolefin composition and a membrane-forming solvent to prepare a first polyolefin solution in an extruder of the type disclosed herein, (2) combining a second polyolefin composition and a second membrane-forming solvent to prepare a second polyolefin solution in an extruder of the type disclosed herein, (3) coextruding the first and second polyolefin solutions through a die to form an extrudate, (4) cooling the extrudate to form a multi-layer, gel-like sheet, (5) removing the membrane-forming solvent from the multi-layer, gel-like sheet to form a solvent-removed gel-like sheet, and (6) drying the solvent-removed gel-like sheet in order to form the multi-layer, microporous membrane. An optional stretching step (7), and an optional hot solvent treatment step (8), etc. can be conducted between steps (4) and (5), if desired. After step (6), an optional step (9) of stretching a multi-layer, microporous membrane, an optional heat treatment step (10), an optional cross-linking step with ionizing radiations (11), and an optional hydrophilic treatment step (12), etc., can be conducted if desired. The order of the optional steps is not critical.

In this form, the first and second polyolefin solutions are co-extruded using a coextrusion die, wherein a planar surface of a first extrudate layer formed from the first polyolefin solution is in contact with a planar surface of a second extrudate layer formed from the second polyolefin solution. A planar surface of the extrudate can be defined by a first vector in the machine direction (MD) of the extrudate and a second vector in the transverse direction (TD) of the extrudate.

In one form, the first extruder containing the first polyolefin solution is connected to a second die section for producing a first skin layer and a third die section for producing a second skin layer, and a second extruder containing the second polyolefin solution is connected to a first die section for producing a core layer. The resulting layered extrudate can be co-extruded to form a three-layer extrudate comprising a first and a third layer constituting skin or surface layers produced from the first polyolefin solution; and a second layer constituting a core or intermediate layer of the extrudate situated between and in planar contact with both surface layers, where the second layer is produced from the second polyolefin solution.

While the extrusion has been described in terms of producing two and three-layer extrudates, the extrusion step is not limited thereto. For example, a plurality of dies and/or die assemblies can be used to produce multi-layer extrudates having four or more layers using the principles of the extrusion dies and methods disclosed herein.

All patents, test procedures, and other documents cited herein, including priority documents, are fully incorporated by reference to the extent such disclosure is not inconsistent and for all jurisdictions in which such incorporation is permitted.

While the illustrative forms disclosed herein have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all the features of patentable novelty which reside herein, including all features which would be treated as equivalents thereof by those skilled in the art to which this disclosure pertains.

When numerical lower limits and numerical upper limits are listed herein, ranges from any lower limit to any upper limit are contemplated.

1. An extruder for preparing a mixture of polymer and diluent, the extruder comprising:
(a) an elongated housing having an inlet end, an outlet end and a bore disposed within said housing;
(b) an elongated extruder shaft having an axis of rotation, said elongated extruder shaft disposed within said bore and drivable in at least one direction of rotation;
(c) a plurality of extruder screw segments positioned along said extruder shaft in a fixed angular relationship therewith, said plurality of extruder screw segments selected to form multiple extruder stages, said multiple extruder stages comprising an inlet stage, a dispersion stage, and at least one mixing stage, said plurality of extruder screw segments forming said at least one mixing stage comprising a reverse mixing screw segment having a helical flight that traverses and forms an outer periphery thereof, said helical flight having a plurality of notches positioned therealong;
(d) a material inlet adjacent said inlet end of said elongated barrel for introducing at least one polymer; and
(e) a first fluid inlet located within said dispersion stage for introducing at least one diluent.

2. The extruder of claim 1, further comprising a second mixing stage, said plurality of extruder screw segments forming said second mixing stage comprising a reverse mixing screw segment having a length of from about 0.50 D to about 1.50 D, wherein D is the screw segment's diameter, said reverse mixing screw segment having a helical flight that traverses and forms an outer periphery thereof, said helical flight having a plurality of notches positioned therealong.

3. The extruder of claim 1 further comprising an outlet stage, said plurality of extruder screw segments forming said outlet stage comprising eight first forward full flight screw segments, three second forward full flight screw segments and three third forward full flight screw segments.

4. The extruder of claim 3, wherein said outlet stage has a length Lₒ of about 0% L≦Lₒ≦ about 40% L, where L is the total length of said extruder shaft.

5. The extruder of claim 1, wherein said at least one mixing stage is a first mixing stage further comprising five gear kneading segments, each gear kneading segment including a plurality of multi-tooth disks.

6. The extruder of claim 5, wherein said first mixing stage has a length Lₘ₁ of about 10% L≦Lₘ₁≦ about 20% L, where L is the total length of said extruder shaft.

7. The extruder of claim 2, wherein said second mixing stage further comprises three pre-kneading segments followed by a plurality of gear kneading segments.

8. The extruder of claim 7, wherein said second mixing stage has a length Lₘ₂ of about 0% L≦Lₘ₂≦ about 20% L, where L is the total length of said extruder shaft.

9. The extruder of claim 2, wherein said dispersion stage comprises at least one kneading segment comprising 17 kneading disks, wherein each adjacent flight tip of each kneading disk is progressively offset by an angle θ equal to about 45°.

10. The extruder of claim 9, wherein said dispersion stage has a length L_{d} of about 15% L≦L_{d}≦ about 25% L, where L is the total length of said extruder shaft.

11. A twin screw extruder for preparing a mixture of polymer and diluent, the extruder comprising:
(a) an elongated housing having an inlet end, an outlet end and a pair of interconnecting bores disposed within said housing;
(b) a pair of elongated extruder shafts each having an axis of rotation, said pair of elongated extruder shafts disposed within said pair of interconnecting bores and drivable in at least one direction of rotation,
(c) a plurality of extruder screw segments positioned along said pair of elongated extruder shafts in a fixed angular relationship therewith, said plurality of extruder screw segments selected to form multiple extruder stages, said multiple extruder stages comprising an inlet stage, a dispersion stage, and at least one mixing stage, said plurality of extruder screw segments forming said at least one mixing stage comprising a reverse mixing screw segment having a length of from about 0.50 D to about 1.50 D, wherein D is the screw segment's diameter, said reverse mixing screw segment having a helical flight that traverses and forms an outer periphery thereof, said helical flight having a plurality of notches positioned therealong;
(d) a material inlet adjacent said inlet end of said elongated barrel for introducing at least one polymer; and
(e) a first fluid inlet located within said dispersion stage for introducing at least one diluent.

12. The twin screw extruder of claim 11, further comprising a second mixing stage, said plurality of extruder screw segments forming said second mixing stage comprising a reverse mixing screw segment having a length of from about 0.50 D to about 1.50 D, wherein D is the screw segment's diameter, said reverse mixing screw segment having a helical flight that traverses and forms an outer periphery thereof, said helical flight having a plurality of notches positioned therealong.

13. The twin screw extruder of claim 11, further comprising an outlet stage, said plurality of extruder screw segments forming said outlet stage comprising eight first forward full flight screw segments, three second forward full flight screw segments and three third forward full flight screw segments.

14. The twin screw extruder of claim 13, wherein said outlet stage has a length Lₒ of about 0% L≦Lₒ≦ about 40% L, where L is the total length of said extruder shaft.

15. The twin screw extruder of claim 11, wherein said at least one mixing stage is a first mixing stage further comprising five gear kneading segments, each gear kneading segment including a plurality of multi-tooth disks.

16. The twin screw extruder of claim 15, wherein said first mixing stage has a length Lₘ₁ of about 10% L≦Lₘ₁≦ about 20% L, where L is the total length of said extruder shaft.

17. The twin screw extruder of claim 12, wherein said second mixing stage further comprises three pre-kneading segments followed by a plurality of gear kneading segments.

18. The twin screw extruder of claim 12, wherein said second mixing stage has a length Lₘ₂ of about 10% L≦Lₘ₂≦ about 20% L, where L is the total length of said extruder shaft.

19. A process for extruding a mixture of polymer and diluent comprising:
(a) blending at least one polymer at a rate of P in an inlet stage and conducting the blended polymer to a dispersion stage;
(b) adding at least one diluent to the blended polymer in the dispersion stage at a rate of S, the diluent having a lower viscosity than the polymer, dispersing the diluent in the polymer, and conducting the dispersed diluent to a first mixing stage, the first mixing stage including a reverse mixing screw segment having a helical flight that traverses and forms an outer periphery thereof, the helical flight having a plurality of notches positioned therealong; and
(c) blending the dispersed diluent and the blended polymer in the first mixing stage to produce a third stage product, the third stage product comprising (i) the polymer-diluent mixture in a first phase, (ii) a portion of the diluent in a second phase separate from the first phase, and (iii) a portion of the polymer in a third phase separate from the first and second phases;
wherein the mixing energy in the first mixing stage is greater than the mixing energy in either the inlet stage or the dispersion stage.

20. The process of claim 19, wherein the first phase is produced at a rate of R, with R being about 0.9×(P+S) or greater.

21. The process of claim 19, wherein the second phase is produced at a rate that does not exceed 0.05×S.

22. The process of claim 19, wherein the third phase is produced at a rate that does not exceed 0.05×P.

23. The process of claim 19, wherein the rate of countercurrent diluent flow from the second region to the first region does not exceed 0.1×S.

24. The process of claim 19, further comprising the steps of:
(d) extruding the polymer-diluent mixture solution through an extrusion die, the extrusion die comprising a slotted die outlet through which a stream of the polymer-diluent mixture is extruded; and
(e) cooling the extrudate to form a cooled extrudate.

25. The process of claim 19, further comprising the steps of:
(f) removing at least a portion of the diluent from the cooled extrudate to form a diluent-removed cooled extrudate;
(g) drying the diluent-removed cooled extrudate to form the microporous membrane; and
(h) stretching the cooled extrudate and/or the microporous membrane.
